(19) United States
(12) Patent Application Publication
(10) Pub. No.: US 2024/0039314 A1
(43) Pub. Date: Feb. 1, 2024

(54) MOBILE CHARGERS

(71) Applicant: MILWAUKEE ELECTRIC TOOL CORPORATION, Brookfield, WI (US)

(72) Inventors: Keith A. Grider, Chicago, IL (US); Caroline G. Fox, Richfield, WI (US); Michael S. Van Dyke, Wauwatosa, WI (US); Joseph S. Wilinski, JR., Wauwatosa, WI (US); Chloe A. Nelson-Arzuaga, Milwaukee, WI (US); Kevin D. White, Milwaukee, WI (US); Devlin N. Thyne, Milwaukee, WI (US); Matthew Post, Milwaukee, WI (US); Nicole A. Baah, Wauwatosa, WI (US); Benjamin A. Smith, Milwaukee, WI (US)

(21) Appl. No.: 18/361,696

(22) Filed: Jul. 28, 2023

Related U.S. Application Data
(60) Provisional application No. 63/394,275, filed on Aug. 1, 2022.

(51) Int. Cl. H02J 7/00; B60L 53/80; B60L 53/30; B60L 53/60

(52) U.S. Cl. CPC H02J 7/0045; H02J 7/0013; H02J 7/0047; B60L 53/80; B60L 53/30; B60L 53/60; B60L 2200/40

(57) ABSTRACT

A mobile charger for transporting and charging a plurality of batteries. The mobile charger includes a base including a bottom portion and a top portion extending from the bottom portion, a docking station slidably coupled to the top portion of the base such that the docking station is movable along the base, and a plurality of charger interfaces coupled to the docking station. The plurality of charger interfaces is configured to receive the plurality of batteries such that the plurality of batteries is charged by the base.

### CROSS-REFERENCE TO RELATED APPLICATIONS

The present application claims priority to U.S. Provisional Patent Application No. 63/394,275, filed Aug. 1, 2022, the entire content of which is incorporated herein by reference.

### FIELD OF THE DISCLOSURE

The present disclosure relates to mobile charging equipment, and more particularly mobile charging equipment for outdoor power equipment.

### BACKGROUND

Outdoor power equipment, such as lawnmowers, leaf blowers, chainsaws, etc., may be powered by rechargeable batteries.

### SUMMARY

The present disclosure provides, in one aspect, a mobile charger for transporting and charging a plurality of batteries. The mobile charger includes a base including a bottom portion and a top portion extending from the bottom portion, a docking station slidably coupled to the top portion of the base such that the docking station is movable along the base, and a plurality of charger interfaces coupled to the docking station. The plurality of charger interfaces is configured to receive the plurality of batteries such that the plurality of batteries is charged by the base.

The present disclosure provides, in another aspect, a mobile charger for transporting and charging a plurality of batteries. The mobile charger includes a base including a bottom portion and a top portion having a pair of slots and a docking station including a pair of railings received within the pair of slots of the top portion of the base to slidably couple the docking station to the base such that the docking station is movable along the base. The mobile charger further includes a plurality of charger interfaces coupled to the docking station. The plurality of charger interfaces is configured to receive the plurality of batteries such that the plurality of batteries is charged by the base.

The present disclosure provides, in another aspect, a mobile charging system including a first mobile charger including a first base, a first docking station slidably coupled to the first base such that the first docking station is movable along the first base, and a first plurality of charger interfaces coupled to the first docking station. The first plurality of charger interfaces is configured to receive a first plurality of batteries such that the first plurality of batteries is charged by the first base. The mobile charging system further includes a second mobile charger including a second base, a second docking station slidably coupled to the second base such that the second docking station is movable along the second base, and a second plurality of charger interfaces coupled to the second docking station. The second plurality of charger interfaces is configured to receive a second plurality of batteries such that the second plurality of batteries is charged by the second base. The first mobile charger and the second mobile charger are coupled together.

### BRIEF DESCRIPTION OF DRAWINGS

FIG. 1 is a perspective view of a mobile charging station according to an embodiment of the present disclosure.

FIG. 2 is a front view of the mobile charging station of FIG. 1.

FIG. 3 is a perspective view of a mobile charging station according to an embodiment of the present disclosure.

FIG. 4 is a front view of the mobile charging station of FIG. 3.

FIG. 5 is a perspective view of multiple mobile charging stations according to an embodiment of the present disclosure.

FIG. 6 is a front view of the mobile charging stations of FIG. 5.

FIG. 7 is a top view of a modular storage unit according to an embodiment of the present disclosure, the modular storage unit including a docking station of the mobile charging station of FIG. 1.

FIG. 8 is a perspective view of the mobile charging station of FIG. 1 coupled to a zero-turn lawn mower according to an embodiment of the present disclosure.

FIG. 9 is a top view of a modular storage unit in an open position according to an embodiment of the present disclosure.

FIG. 10 is a cross-sectional view of the modular storage unit of FIG. 9.

FIG. 11 is a perspective view of the modular storage unit of FIG. 9 in a closed position.

FIG. 12 is a perspective view of a modular charging unit in a closed position according to an embodiment of the present disclosure.

FIG. 13 is a perspective view of the modular charging unit of FIG. 12 in an open position.

FIG. 14 is a perspective view of a charging cabinet according to an embodiment of the present disclosure.

FIG. 15 is a side view of the charging cabinet of FIG. 14.

FIG. 16 is a perspective view of a locking assembly used on the charging cabinet of FIG. 14.

FIG. 17 is a perspective view of a hasp used on the charging cabinet of FIG. 14.

FIG. 18 is schematic diagram of a cargo trailer including the charging cabinet of FIG. 14.

FIG. 19 is a perspective view of a charging station according to an embodiment of the present disclosure, the charging station for double-wide-sized batteries.

FIG. 20 is a perspective view of a charging station according to an embodiment of the present disclosure, the charging station for single-wide-sized batteries.

FIG. 21 is a perspective view of a tool rack charger according to an embodiment of the present disclosure.

FIG. 22 is a perspective view of the tool rack charger of FIG. 21 with portions removed, the tool rack charger in a closed position.

FIG. 23 is a perspective view of the tool rack charger of FIG. 21 with portions removed, the tool rack charger in an open position.

FIG. 24 is an enlarged view of the tool rack charger of FIG. 21.

FIG. 25 is an enlarged view of the tool rack charger of FIG. 21, illustrating a locking element.

FIG. 26 is a front view of a battery locker assembly according to an embodiment of the present disclosure.

FIG. 27 is a perspective view of a battery charging tailgate according to an embodiment of the present disclosure, the battery charging tailgate in a closed positioned.

FIG. 28 is a perspective view of the battery charging tailgate of FIG. 27, the battery charging tailgate in an open position.

FIG. 29 is a schematic diagram of a security system, according to an embodiment of the present disclosure.

FIG. 30 is a schematic diagram of the security system of FIG. 29.

FIG. 31 is a schematic diagram of the security system of FIG. 29.

FIG. 32 is a block diagram of a method performed by the security system of FIG. 29, according to an embodiment of the present disclosure.

FIG. 33 is a block diagram of a method performed by the security system of FIG. 29, according to an embodiment of the present disclosure.

FIG. 34 is a perspective view of a charging station, according to an embodiment of the present disclosure.

FIG. 35 is a perspective view of the charging station of FIG. 34.

FIG. 36 is a perspective view of a battery compartment of the charging station of FIG. 34.

FIG. 37 is a perspective view of the battery compartment of the charging station of FIG. 36.

FIG. 38 is a perspective view of a battery pad on an enclosed cargo trailer, according to an embodiment of the present disclosure.

FIG. 39 is a perspective view of the battery pad of FIG. 38 on a flatbed trailer.

FIG. 40 is a perspective view of a floor hatch in a closed position, according to an embodiment of the present disclosure.

FIG. 41 is a perspective view of the floor hatch of FIG. 40 in an open position.

FIG. 42 is a front view of a charging door, according to an embodiment of the present disclosure.

FIG. 43 is a rear perspective view of the charging door of FIG. 42.

FIG. 44 is an enlarged view of the charging door of FIG. 42.

FIG. 45 is a perspective view of battery chargers coupled to an E-track attached to an enclosed cargo trailer, according to an embodiment of the present disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

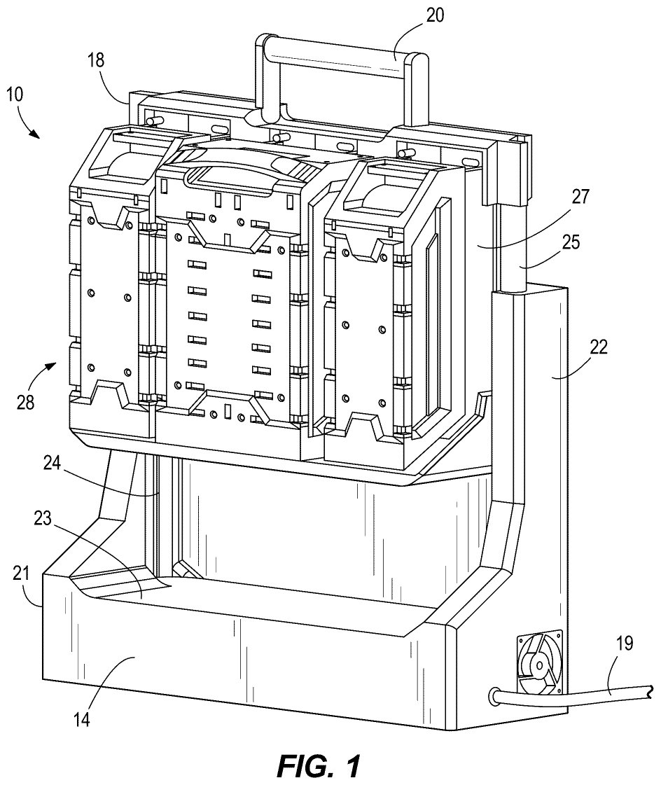

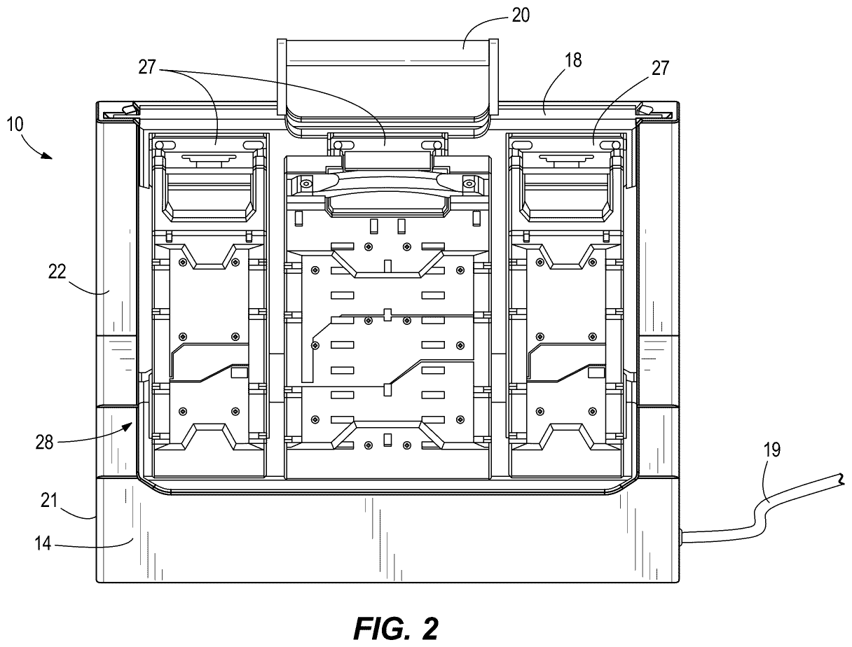

FIGS. 1 and 2 illustrate a mobile charging station 10 according to one embodiment. The mobile charging station 10 provides a safe and reliable way to transport multiple batteries around a jobsite. The mobile charging station 10 is a lightweight mobile charger that may weigh under 40 lbs. when batteries are loaded onto the mobile charging station 10. In addition, the mobile charging station 10 can be provided at different charging rates (e.g., supercharger base or simultaneous charger base). As such, the mobile charging station 10 is configured to charge the batteries at a fast charging rate or a standard charging rate. For example, when the mobile charging station 10 has a fast charging rate, the batteries may be charged in a first time period (e.g., 30 minutes or a three-C rate) that is less than a second time period (e.g., 90 minutes or a one-C rate) it takes to charge the batteries at a standard charging rate.

The mobile charging station 10 includes a base 14, a docking station 18 supported by and slidably coupled to the base 14, a power cord 19 configured to connect the mobile charging station 10 to a power supply, and a handle 20 coupled to the docking station 18. The base 14 includes a bottom portion 21 and a top portion 22 extending from the bottom portion 21. The bottom portion 21 is formed as a platform defining a docking surface 23. The top portion 22 of the base 14 is formed as a wall and has a pair of slots 24. The base 14 is configured to store the charging electronics to serve as a charger, thereby reducing the weight of the docking station 18. In some embodiments, the charging electronics may be stored in the docking station 18 so that the docking station 18 serves as a charger. In other embodiments, the charging electronics may be stored in the base 14 and the docking station 18 so that the base 14 and the docking station 18 serve as a charger together.

The docking station 18 includes a pair of railings 25 formed on opposite sides of the docking station 18. The railings 25 of the docking station 18 are configured to be slidably received within the slots 24 of the top portion 22 of the base 14. The handle 20 is configured to be grasped by a user to slidably move the docking station 18 along the base 14. In addition, the handle 20 can be used to remove the docking station 18 from the base 14.

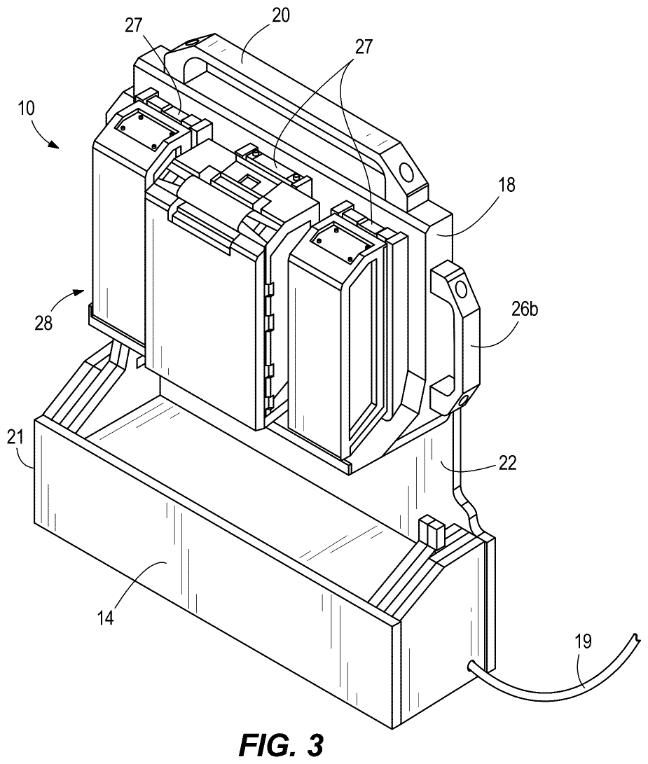

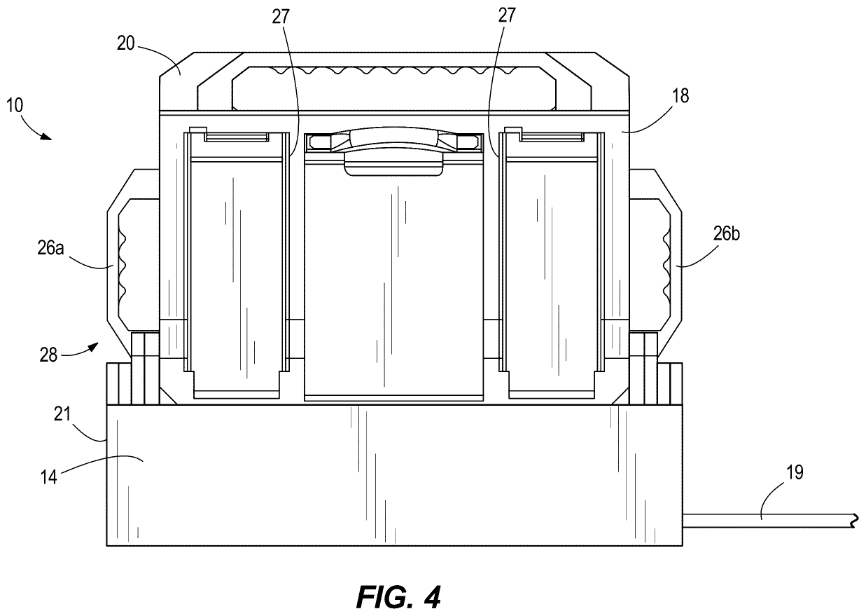

The handle 20 can also be grasped by the user for transporting the mobile charging station 10. Moreover, the handle 20 is retractable into the docking station 18, thereby allowing the mobile charging station 10 to fit and be placed in narrow and small spaces. In other embodiments, as illustrated in FIGS. 3 and 4, the mobile charging station 10 further includes a first side handle 26a and a second side handle 26b extending from opposite sides of the docking station 18, while a primary handle or the handle 20 extends from a top portion of the docking station 18. The user can also grasp the first and second side handles 26a, 26b to remove the docking station 18 from the base 14.

With continued reference to FIGS. 1-4, the docking station 18 includes a plurality of charger interfaces 27 configured to receive and support batteries 28. The batteries 28 are rechargeable power tool battery packs having a nominal output voltage of 18 V. As such, the mobile charging station 10 is configured to sequentially charge the batteries 28 that are connected to the charger interfaces 27. In the illustrated embodiment, the docking station 18 has three charger interfaces 27. In other embodiments, the docking station 18 can have two charger interfaces 27 or four charger interfaces 27. The mobile charging station 10 further includes a forced-air cooling system to control a temperature of the mobile charging station 10.

The mobile charging station 10 is also configured to hold and organize the batteries 28 during transportation, thereby serving as a common carrier that transports the batteries 28 in various equipment related to the outdoor power equipment (e.g., landscape mobile trailers, tool racks, tailgates on trucks, lawnmowers, etc.). As such, the mobile charging station 10 organizes the batteries 28 in a side-by-side arrangement. When the mobile charging station 10 is transported by various transportation equipment, the batteries 28 can be charged when the mobile charging station 10 is powered by the transportation equipment.

The mobile charging station 10 can be operated in a mode in which the mobile charging system 10 has a power draw that is less than 400 Watts for compatibility with in-truck inverters. Moreover, the mobile charging station 10 has a vehicle-maximum-power-draw sensor system configured to maximize the power draw from a vehicle with a limited power supply source without tripping vehicle brakers.

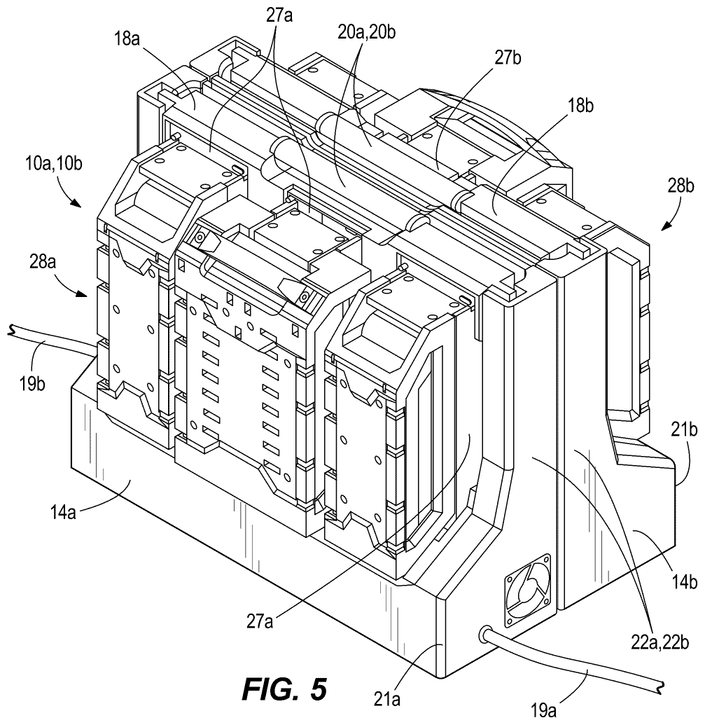

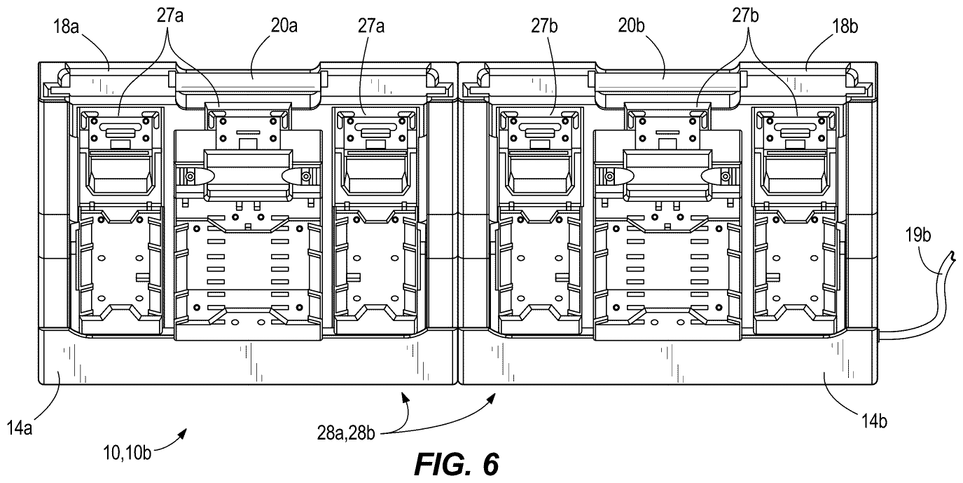

FIGS. 5 and 6 illustrate multiple mobile charging stations 10a, 10b that are similar to the mobile charging station 10 of FIGS. 1 and 2; therefore, like structure will be identified by like reference numbers plus “a” and “b.” The mobile charging stations 10a, 10b can be movably coupled to each other to provide multiple charger interfaces 27a, 27b, in particular, more than four battery chargers. The mobile charging stations 10a, 10b can be arranged side-by-side, or the mobile charging stations 10a, 10b can be arranged back-to-back.

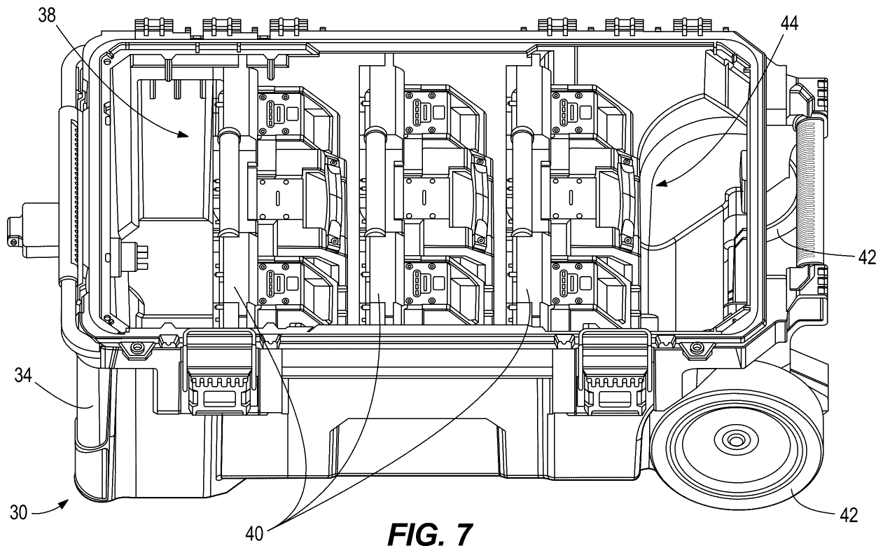

In reference to FIG. 7, a modular storage unit 30 is illustrated. After removing the docking station 18 from the base 14 of the mobile charging station 10, the docking station 18 can be stored in the modular storage unit 30 for ingress protection against water and dust. The modular storage unit 30 includes a housing 34 having a storage compartment 38 configured to securely hold a plurality of docking stations 40 that receive batteries 44. The batteries 44 are configured to be charged by the modular storage unit 30 as the docking stations 40 are docked on the modular storage unit 30. In the illustrated embodiment, the modular storage unit 30 stores three docking stations 40. In other embodiments, the modular storage unit 30 may store less than three docking stations 40. The modular storage unit 30 further includes a pair of wheels 42 for transporting the modular storage unit 30 across a surface.

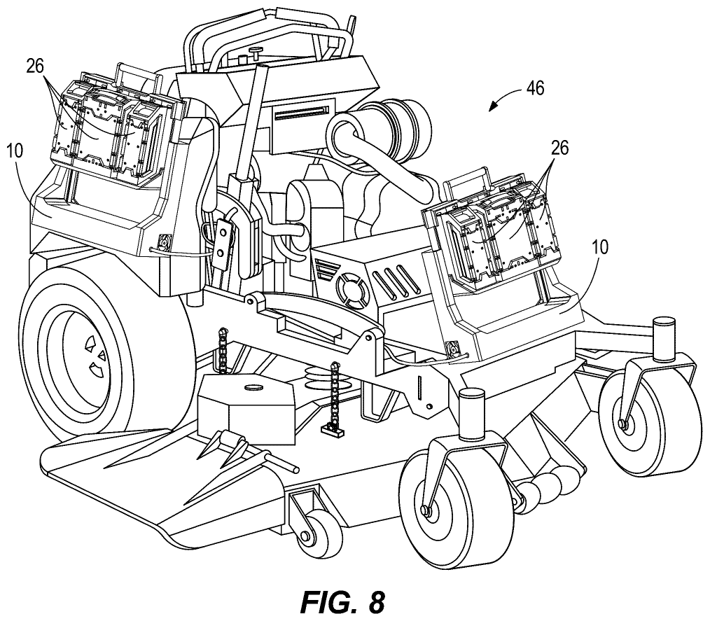

In reference to FIG. 8, the mobile charging station 10 can be coupled to and powered by a zero-turn lawnmower 46. The mobile charging station 10 is to be easily transported with the zero-turn lawnmower 46 during operation of the lawnmower 46. The batteries 28 connected to the mobile charging station 10 can be closely monitored to reduce theft since the batteries 28 are located right next to the user for the duration of a lawn mowing operation. In addition, the batteries 28 are configured to be charged while a user is operating the lawnmower 46, which represents most of the time spent on a job site. Coupling the mobile charging station 10 to the zero-turn lawnmower 46 prevents a user from having to use a generator and from having to leave their truck running to charge batteries while working on a job. As such, no other equipment will be needed to charge the batteries when traveling.

The lawnmower 46 includes a magneto that is onboard a gas engine of the lawnmower 46 and configured to recharge a starter battery located in the lawnmower 46. When the starter battery is fully charged by the magneto, extra current can flow into the batteries 28 to charge the batteries 28. To ensure that the starter battery of the lawnmower 46 is operable when needed, the mobile charging station 10 includes a monitoring system configured to monitor the charge level of the starter battery of the lawnmower 46 and the charge level of the batteries 28 coupled to the docking station 18. The mobile charging station 10 also includes a battery charging automated switching system configured to operated based on the monitoring system. In other embodiments, a separate alternator located within the lawnmower 46 may be used to power the mobile charging station 10. V-twin style engines that may be provided on lawnmowers can produce 14.4 V with 10, 15, or 20 A output, depending on engine size. Older diesel engines provided with lawnmowers may use a belt driven alternator. As such, the mobile charging station 10 can be powered by various components provided within a lawnmower.

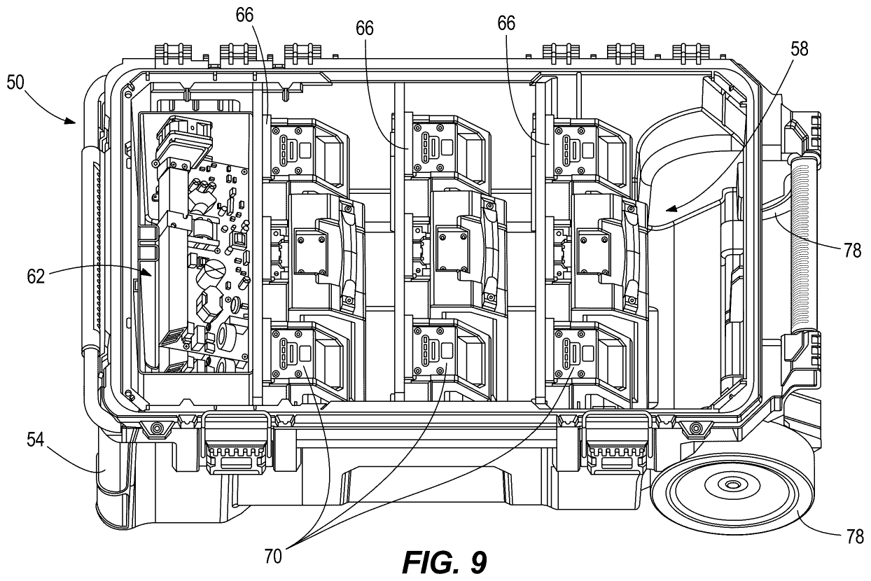

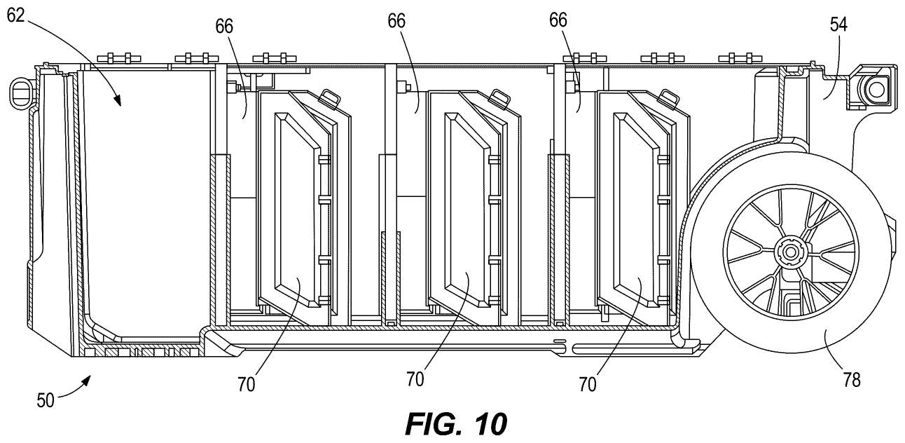

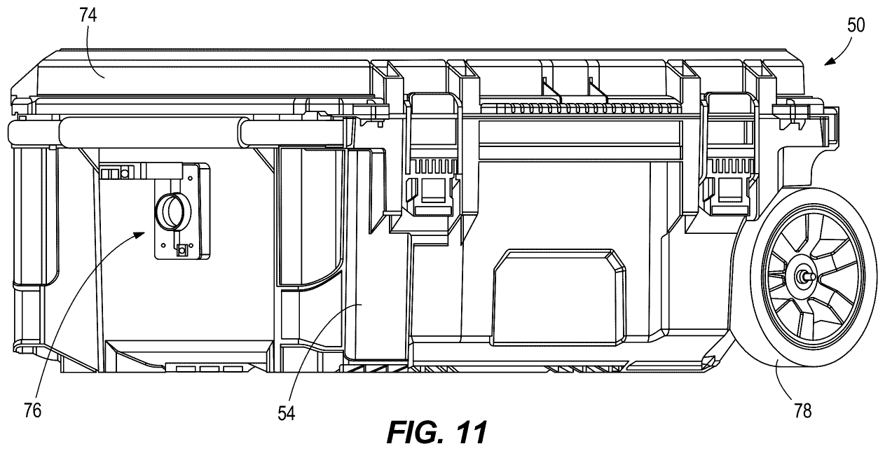

FIGS. 9-11 illustrate another embodiment of a modular storage unit 50 that provides a safe and reliable way to transport multiple batteries at once. Also, the batteries are to be charged within the modular storage unit 50 without having to remove the batteries from the modular storage unit 50. The modular storage unit 50 includes a housing 54 having a storage compartment 58 and a charging compartment 62. The storage compartment 58 includes three storage sections that each has a plurality of battery chargers 66 configured to organize batteries 70 in a side-by-side arrangement. As such, the storage compartment 58 can accommodate three wide batteries 70 and six narrow batteries 70. The battery chargers 66 are configured to receive and provide semi-automated charging to batteries 70 in a sequential manner or a simultaneous manner. In some embodiments, a user may use an actuation member (e.g., a button or a switch) to operate the battery chargers 66. In other embodiments, a user interface may be used to operate the battery chargers 66. The charging compartment 62 includes electrical components used to charge the batteries 70 respectively received within the battery chargers 66. The modular storage unit 50 further includes a 15 Ampere power cord (not shown) configured to be plugged into a wall outlet to charge the batteries 70 inside the modular storage unit 50.

Moreover, the modular storage unit 50 includes an attachment mechanism (e.g., hooks, lashing cleats, rails, not shown) integrally formed along a side of the housing 54. The attachment mechanism is configured to securely couple the modular storage unit 50 to a wall or an enclosed cargo trailer while still providing access to the batteries 70. In addition, the modular storage unit 50 is formed to provide ingress-protected charging to protect the battery changers 66 and the batteries 70 from water and dust that may be present at a jobsite. An internal cooling system is also provided in the modular storage unit 50 to control an internal temperature of the modular storage unit 50.

The modular storage unit 50 includes a lid 74 pivotably coupled to the housing 54 to provide a closed and open configuration of the modular storage unit 50. In an open configuration of the modular storage unit 50, the batteries 70 can be accessible. In a closed configuration of the modular storage unit 50, the lid 74 is securely coupled to the housing 54 by a locking element 76 (e.g., pad lock, latches, etc.) to protect the storage compartment 58 from fluid and dust. The modular storage unit 50 also includes a pair of wheels 78 coupled to a rear portion of the modular storage unit 50. The wheels 78 allow the modular storage unit 50 to be easily transported across a surface.

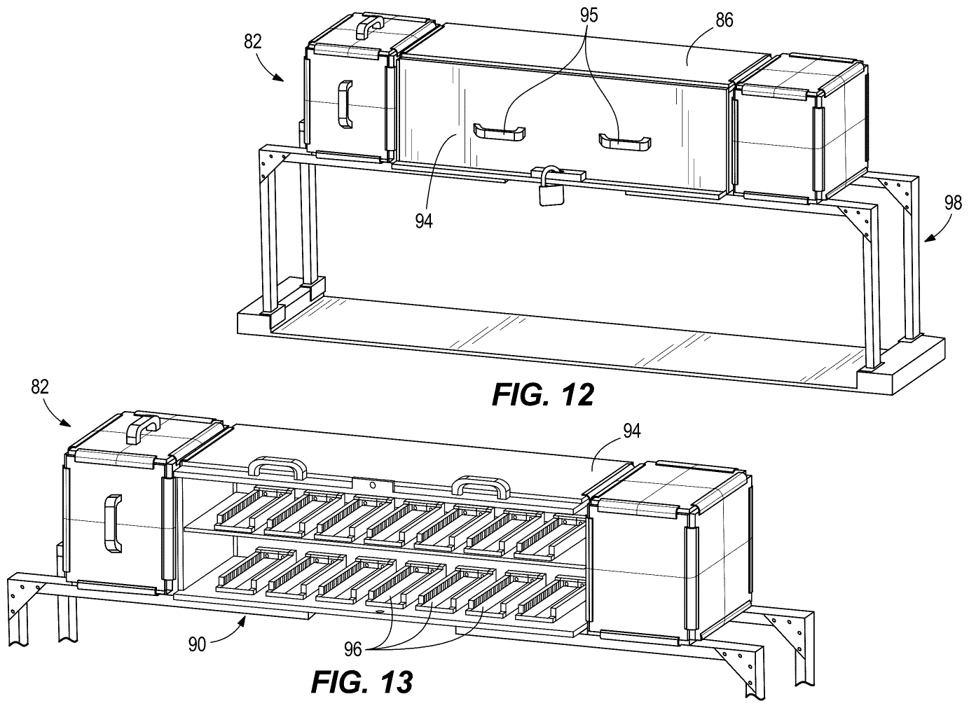

In reference to FIGS. 12 and 13, a modular charging unit 82 is illustrated. The modular charging unit 82 has the ability to charge multiple batteries on an open trailer (e.g., flatbed trailer), thereby eliminating the need for a user to load and unload multiple battery packs each day. The modular charging unit 82 includes a housing 86 having a battery compartment 90 and a door 94 coupled to the housing 86 to enclose the battery compartment 90. The door 94 includes a pair of handles 95 configured to be grasped by a user to lift and slidably move the door 94 relative to the housing 86 to provide access to the battery compartment 90. The battery compartment 90 is configured to hold and store a plurality of battery chargers 96 that are configured to receive and charge multiple batteries (not shown). Specifically, the battery compartment 90 can hold either two double-wide-sized batteries (i.e., wide batteries) or three single-wide-sized batteries (i.e., narrow batteries) for each set of three battery rails. In some embodiments, four sets of battery rails plus one extra rail can be accommodated.

When the modular charging unit 82 is stored on the flatbed trailer, the modular charging unit 82 is positioned on a base 98 to be elevated above a floor surface of the flatbed trailer. As such, elevating the modular charging unit 82 allows a user to charge and store batteries in an open space (e.g., front portion of the flatbed trailer) defined within the trailer. Also, elevating the modular charging unit 82 provides space for outdoor power equipment (e.g., lawnmower, chainsaw, leaf blower, etc.) to pass under the modular charging unit 82. The modular charging unit 82 may also be provided with a mounting assembly for the outdoor power equipment provided in the space under the modular charging unit 82. In some embodiments, a charger or power module can be added to the base 98 based on a user's need.

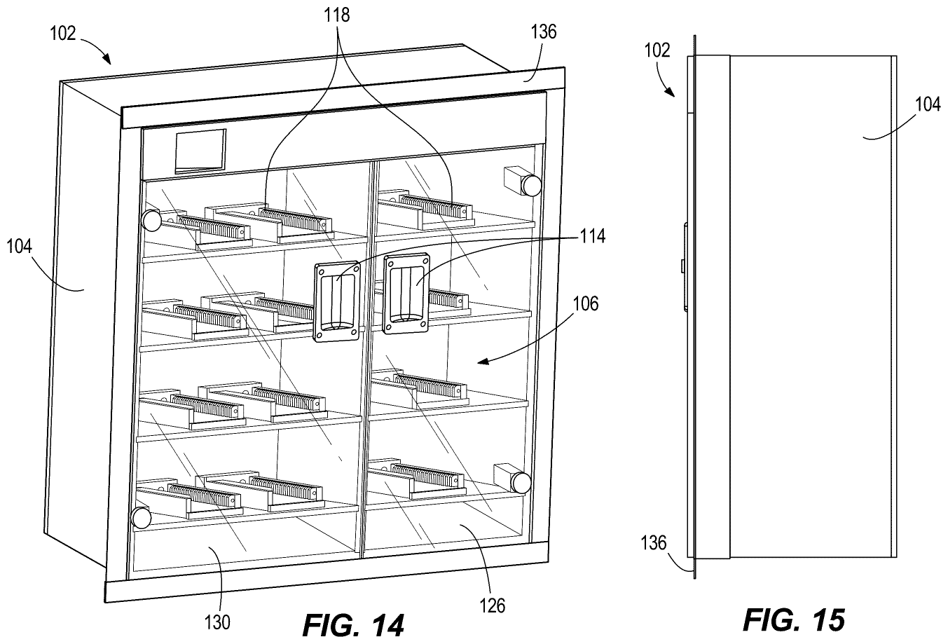

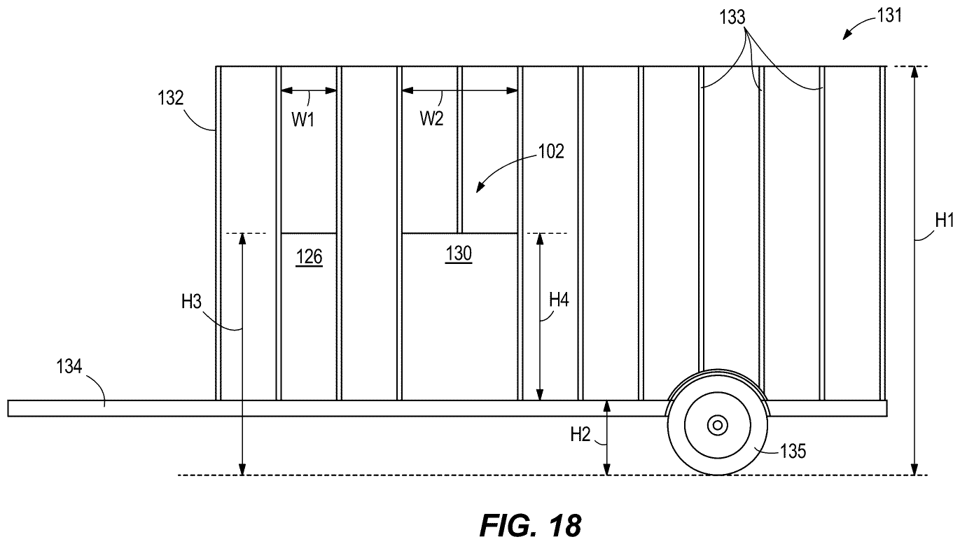

In reference to FIGS. 14-18, a charging cabinet 102 is illustrated. The charging cabinet 102 allows a user to access battery packs from outside an enclosed cargo trailer in a timely manner to avoid loading and unloading battery packs each day at a jobsite. The charging cabinet 102 is configured to be mounted within a wall of the enclosed cargo trailer to be transported with the trailer. The charging cabinet 102 includes a housing 104 having a battery compartment 106, a pair of doors 114 configured to enclose the battery compartment 106, and an exterior AC plug-in (not shown) for overnight charging or charging at an electric vehicle charging station (i.e., EV station). A plurality of battery chargers 118 are stored in the battery compartment 106 and configured to receive and charge batteries (not shown).

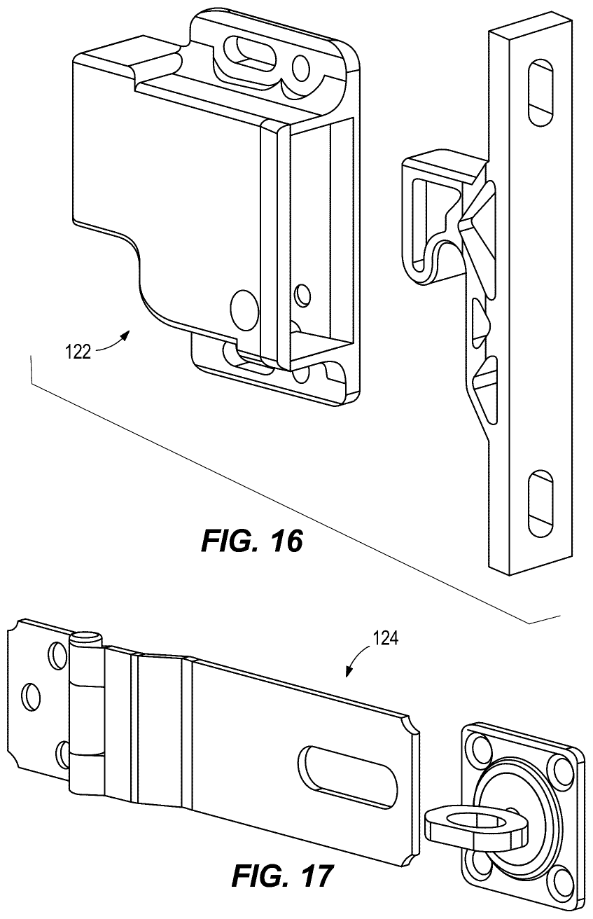

The doors 114 are pivotably coupled to the housing 104 by an interior hinge (not shown) to reduce theft opportunity. In some embodiments, the doors 114 of the charging cabinet 102 can be locked by a locking mechanism 122 illustrated in FIG. 16. In other embodiments, the doors 114 can be locked by a hasp 124 compatible with a padlock, as illustrated in FIG. 17. The housing 104 of the charging cabinet 102 further includes interior lighting to illuminate the housing 104.

For example, the charging cabinet 102 is disposed on an enclosed cargo trailer 131 including a housing 132 defined by a plurality of studs 133, a floor surface 134, and wheels 135. The trailer 131 has a first height H1 defined between a top portion of the studs 133 and a bottom portion of the wheels 135. The first height H1 ranges between 100 inches and 105 inches, and is preferably 103 inches. A second height H2 of the trailer 131 is defined between the floor surface 134 and the bottom portion of the wheels 135. The second height H2 ranges between 23 inches and 27 inches, and preferably is 25 inches. The charging cabinet 102 is disposed on the trailer 131 such that the battery chargers 118 are located in an ergonomic power zone (i.e., a zone defined between the shoulders and the knees of a user) of a user. As such, the charging cabinet 102 is positioned along the floor surface 134 of the trailer 131 such that the charging cabinet 102 is disposed within a third height H3 of the trailer 131. The third height H3 is defined between a top portion of the charging cabinet 102 and the bottom portion of the wheels 135 of the trailer 131. The third height H3 ranges between 54 inches and 58 inches, and is preferably 56 inches. An area defined above the charging cabinet 102 can be used as a storage compartment for other tool equipment (e.g., power tools or outdoor power equipment). At least 15 batteries (e.g., 10 single-wide batteries and 5 double-wide batteries) can be stored in the charging cabinet 102. Hardware is also provided to the user for cutting and mounting the charging cabinet 102 to a wall of a standard enclosed trailer, in which studs of various heights and widths are provided.

The battery compartment 106 includes a first compartment 126 enclosed by one of the doors 114 and a second compartment 130 enclosed by the other of the doors 114. The first compartment 126 has a width W1 ranging between 13 inches and 14 inches, and is preferably 13.5 inches. The second compartment 130 has a width W2 ranging between 29 inches and 30 inches, and is preferably 29.5 inches. Both, the first and second compartment 126, 130 have a height H4 between 30 inches and 32 inches, and is preferably 31 inches.

A frame 136 surrounds the housing 104 of the charging cabinet 102 and is configured to hold the charging cabinet 102 from inside and outside the walls of the enclosed cargo trailer for stability and security. To ensure that the charging cabinet 102 is secured within the enclosed cargo trailer, the charging cabinet 102 can be bolted to a ground surface of the enclosed cargo trailer. The charging cabinet 102 further includes an exterior venting system for conveying air to an exterior of the charging cabinet 102, rather than into the enclosed cargo trailer. In some embodiments, the charging cabinet 102 can also include a refrigeration attachment (i.e., refrigeration system). In other embodiments, the charging cabinet 102 is insulated.

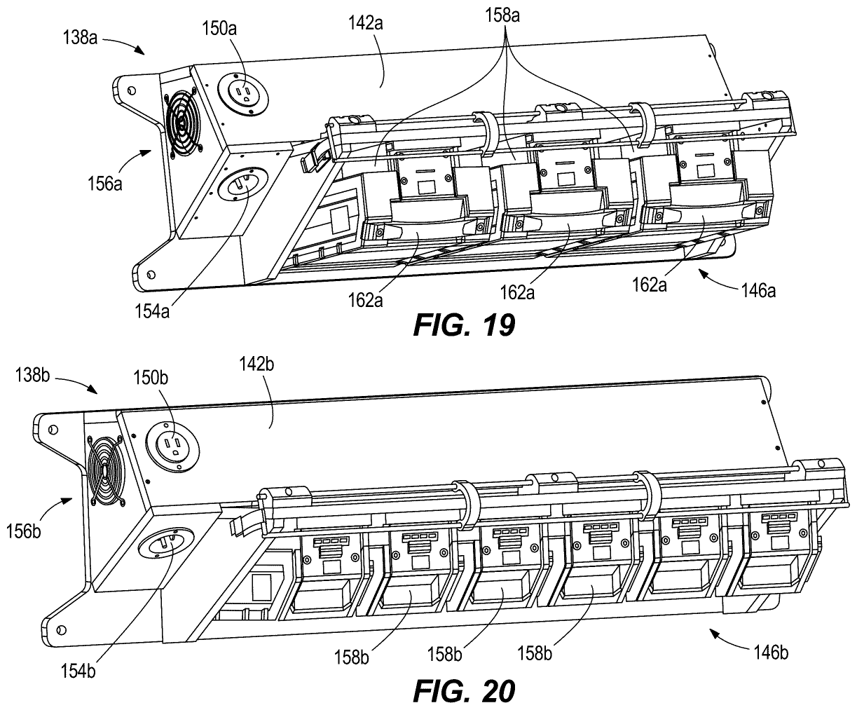

In reference to FIGS. 19 and 20, a first wall-mounted charging station 138a and a second wall-mounted charging station 138b is illustrated. The charging stations 138a, 138b are configured to be mounted on a wall of an enclosed cargo trailer to provide a charging base for battery packs used with outdoor power equipment. With the charging stations 138a, 138b a user can avoid loading and unloading multiple battery packs each day. As such, the charging stations 138a, 138b keep the battery packs off a floor surface of the enclosed cargo trailer and out of the way of other equipment stored in the enclosed cargo trailer.

Each charging station 138a, 138b include a housing 142a, 142b with a charging compartment 146a, 146b, an AC power outlet 150a, 150b, a power inlet 154a, 154b, and a sub-ambient cooling system 156a, 156b to cool the charging stations 138a, 138b. The charging compartment 146a, 146b of each charging station 138a, 138b includes a plurality of battery chargers 158a, 158b configured to receive and charge a plurality of batteries 162a. The charging compartment 146a of the first wall-mounted charging station 138a is sized to hold three double-wide batteries 162a. The charging compartment 146b of the second wall-mounted charging station 138b is sized to hold six single-wide batteries (e.g., ergo, standard, and extended batteries). In some embodiments, multiple of the first and second charging stations 138a, 138b can be mounted in an enclosed cargo trailer and wired in a daisy-chain style so that a single 15 Ampere circuit can connect and charge all of the charging stations 138a, 138b installed within an enclosed cargo trailer. As such, a user can purchase many charging stations 138a, 138b for their trailer. In other embodiments, the charging stations 138a, 138b can accommodate forced-air cooling.

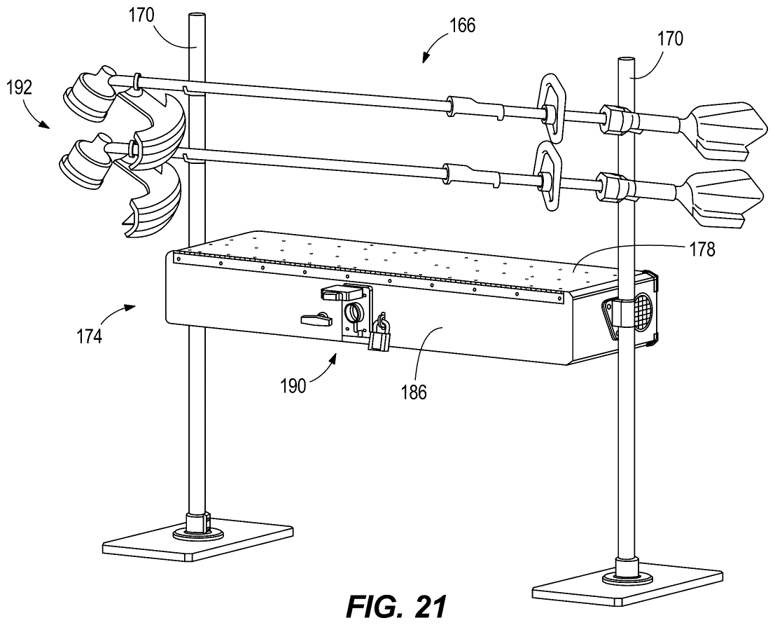

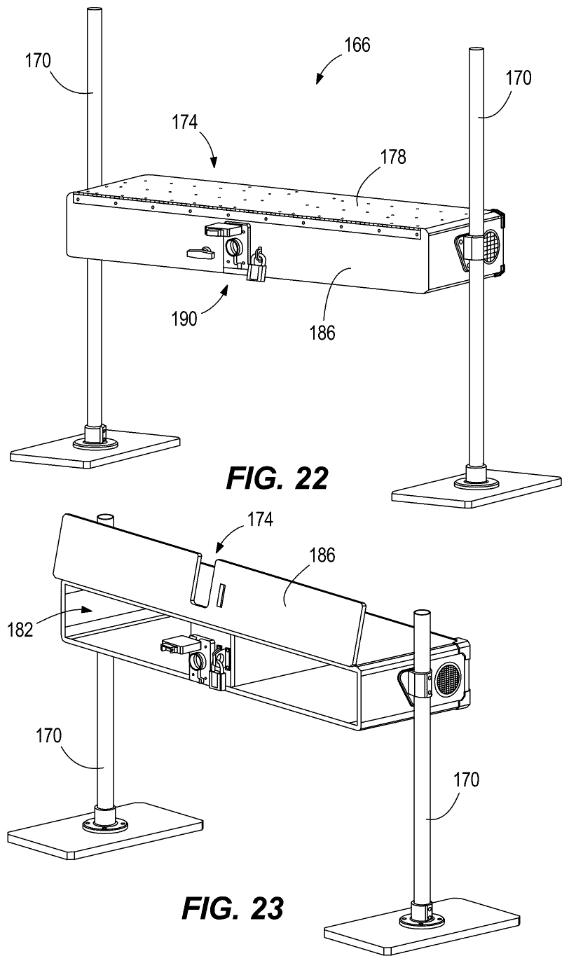

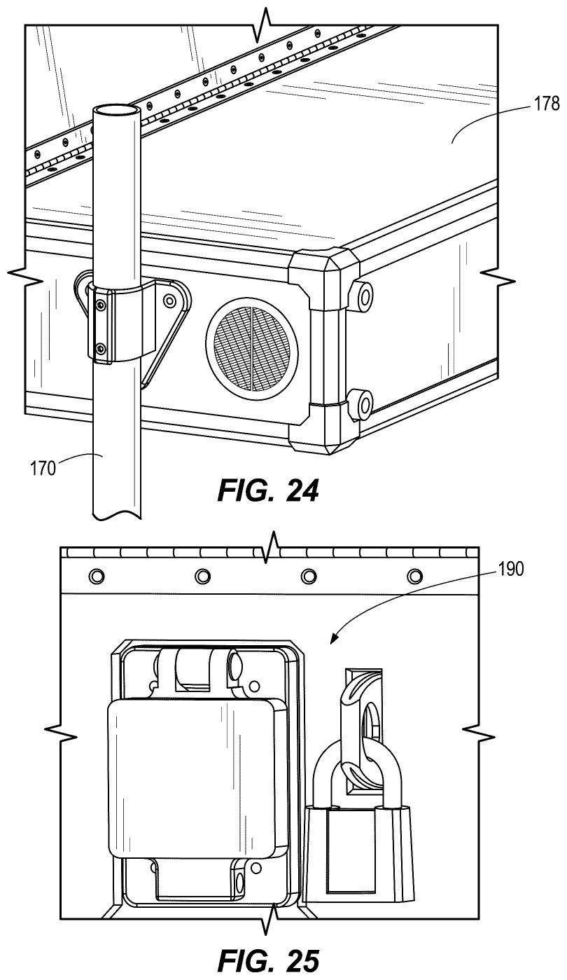

In reference to FIGS. 21-25, a tool rack charger 166 is illustrated. The tool rack charger 166 allows batteries to be stored near tools on a flatbed trailer. The tool rack charger 166 includes a pair of tubular upright posts 170 configured to hold outdoor power equipment 192 (e.g., string trimmer) and a charging station 174 that serves as a battery charger integrated within storage equipment. The charging station 174 includes a housing 178 having a battery compartment 182 configured to store and protect a plurality of batteries (not shown) from weather on the flatbed trailer while the batteries are charging. In other embodiments, the tool rack charger 166 is configured to charge the batteries and the equipment stored thereon. The charging station 174 further includes a lid 186 configured to enclose the battery compartment 182. The lid 186 can be locked by a locking element 190 (e.g., pad lock). As such, the tool rack charger 166 provides easy access to batteries stored and transported on the flatbed trailer.

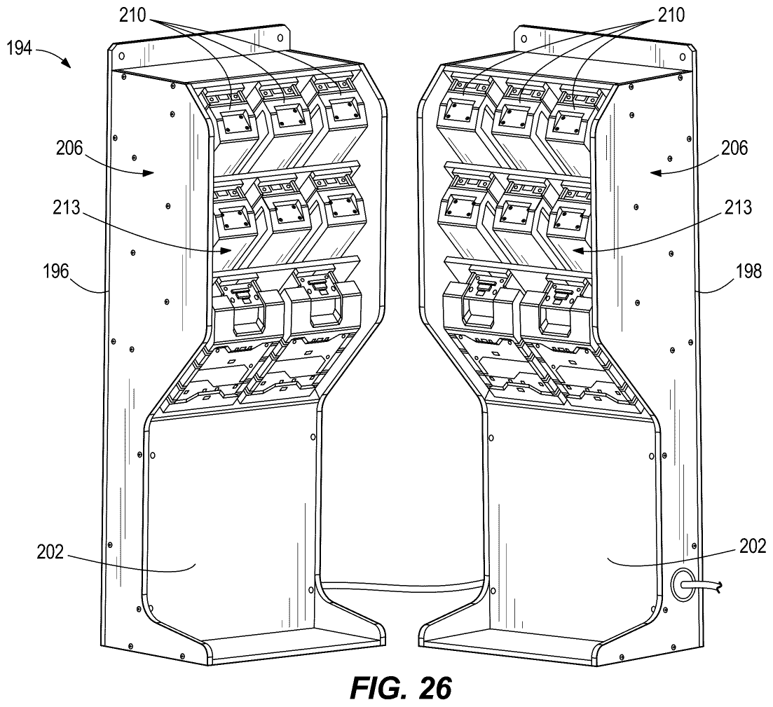

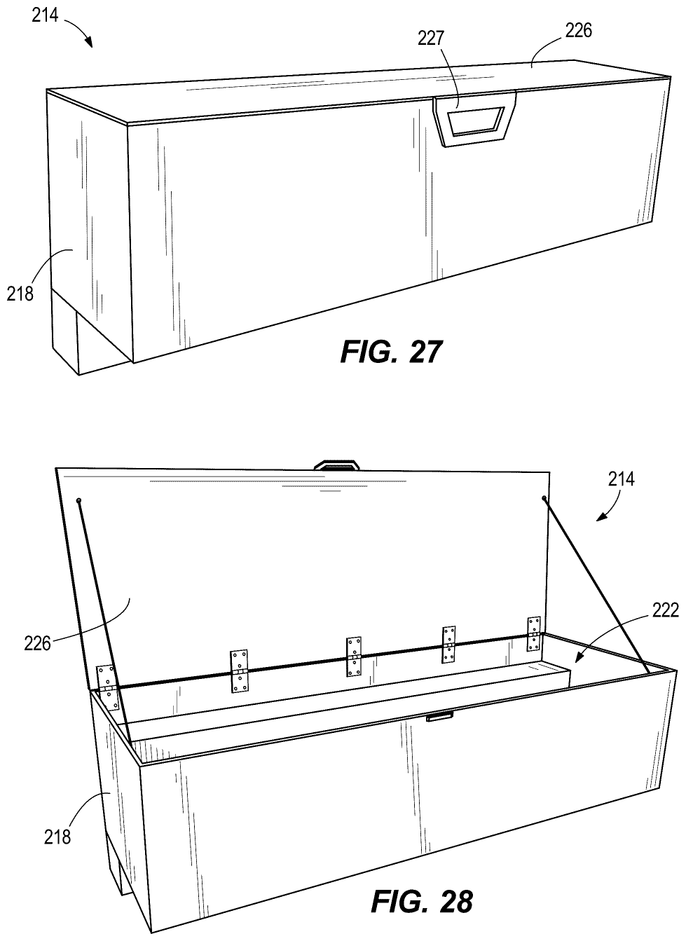

In reference to FIG. 26, a battery locker assembly 194 is illustrated. The battery locker assembly 194 includes a first locker 196 and a second locker 198. The first and second lockers 196,198 each include a base 202 and a battery compartment 206. The base 202 of each locker 196, 198 is configured to be permanently mounted to a floor surface of an enclosed cargo trailer to support the first and second lockers 196, 198. The battery compartment 206 of each locker 196, 198 has a plurality of battery chargers 210 configured to receive and charge a plurality of batteries 213. Also, the battery compartment 206 of each locker 196, 198 is positioned at an upper portion of each locker 196, 1968, so that the batteries 213 are elevated to hang over the floor of the trailer. As such, the structure of the battery locker assembly 194 allows the battery locker assembly 194 to be positioned at a nose portion and/or a front portion of the trailer or a truck. The battery locker assembly 194 can also be permanently mounted to a wall of the trailer to securely mount the battery locker assembly 194 to the trailer. In addition, the battery locker assembly 194 further includes electric passthrough components to allow the batteries 213 to be charged overnight.

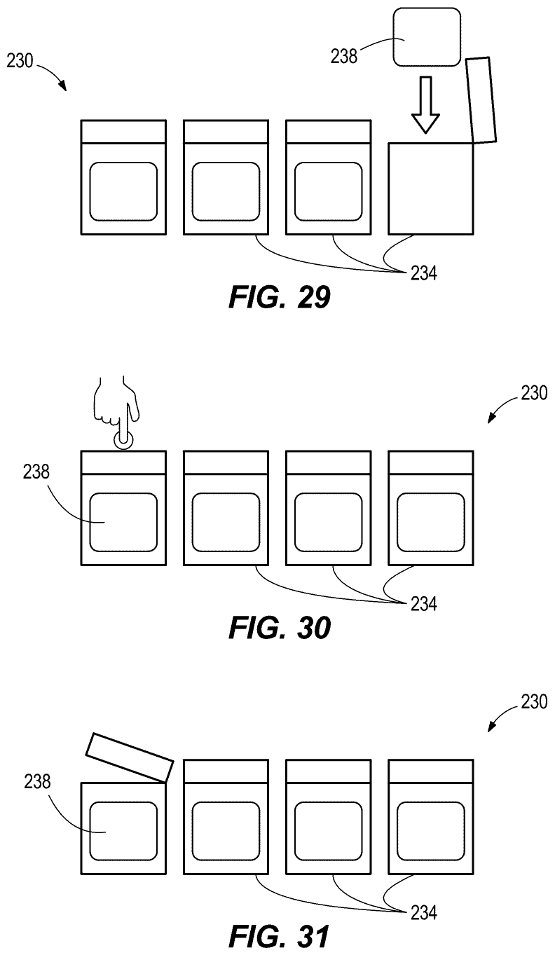

In reference to FIGS. 28 and 29, a battery charging tailgate 214 is illustrated. The tailgate 214 is configured to replace an original tailgate provided on a truck to integrate a battery charging and storing tailgate within a truck. The tailgate 214 can be designed to be used with various truck makes and models (e.g., Ford, Chrysler, Chevy, Toyota, Nissan, etc.).

The tailgate 214 includes a housing 218 having a battery compartment 222, a lid 226 pivotably coupled to the housing 218 to enclose the battery compartment 222, and a power cord (not shown) configured to connect to a power supply when stored in a receptacle. The battery compartment 222 is configured to be used for storing and charging a plurality of batteries (not shown). In some embodiments, the tailgate 214 includes a door (not shown) configured to flip down to provide access to a bed of the truck like a standard tailgate. The tailgate 214 can be user adjustable. As such, a width of the tailgate 214 and a pivot established by the lid 226 of the tailgate 214 can be modified to accommodate the size of a truck. An inverter is also integrated within the tailgate 214 for charging various power tools or devices to provide On-the-Go (OTG) charging. The tailgate 214 further includes a lockable compartment (not shown) within the housing 218 and separate from the battery compartment 222 to provide a compartment for storing various equipment (e.g., power tools, personal devices, etc.).

FIGS. 29-31 illustrate a security system 230 for securely storing various devices (e.g., power tools, batteries, etc.) and allowing minimal access time to stored devices. As such, the security system 230 provides a give-one, get-one locking concept. The security system 230 includes a plurality of compartments 234 configured to store a device 238 and a locking mechanism provided to secure the compartments 234. The compartments 234 also control wear (i.e., health of device) of the device 238 by controlling how often a user has physical access to the device 238. In the case that identical devices 238 are worn out, the security system 230 can help evenly distribute device usage so that wear occurs evenly. In addition, the security system 230 can replenish or refill devices 238 stored inside the compartments 234 (i.e., batteries, fluids).

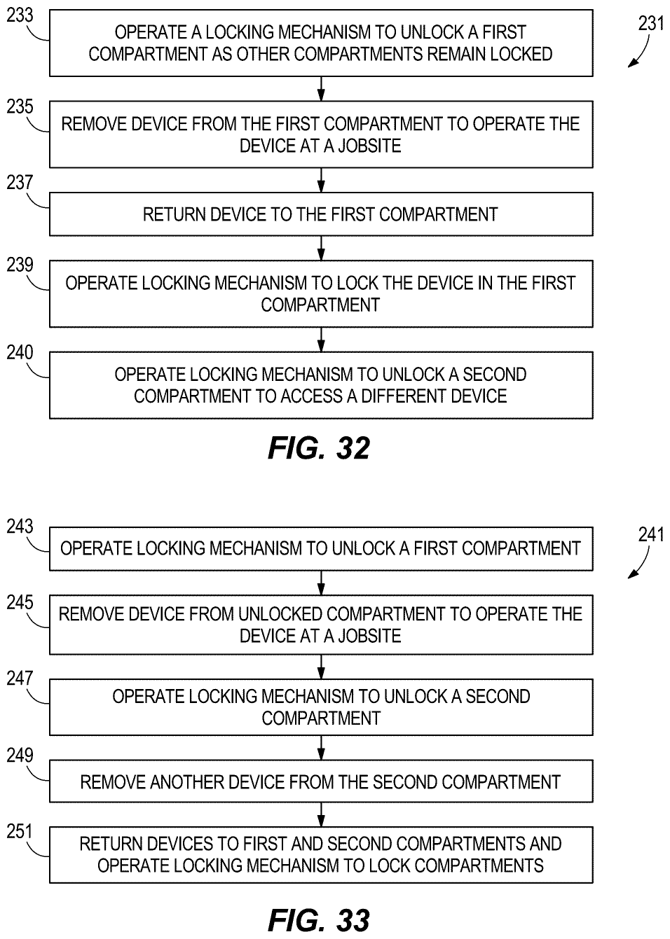

FIG. 32 provides a method 231 for performing a first security mode. The method 231 is performed by the locking mechanism of the security system 230. At block 233, a user operates the locking mechanism of the security system 230 to unlock a first compartment 234. At block 235, the user removes a device 238 from the first compartment 234 to operate the device 238 at a jobsite. As the first compartment 234 is unlocked, the other devices 238 remain locked in the compartments 234 or in-hand of the user. At block 237, the user returns the device 238 to the first compartment 234. At block 239, the user operates the locking mechanism to lock the device 238 within the first compartment 234. At block 240, the user operates the locking mechanism to unlock a second compartment 234 to have access to a different device 238. As such, the first mode allows a user to remove only one device 238 from the security system 230. It is necessary for the user to return a previous device 238 to access another compartment 234.

FIG. 33 provides a method 241 for performing a second security mode. The method 241 is performed by the locking mechanism of the security system 230. At block 243, a user operates the locking mechanism of the security system 230 to unlock a first compartment 234. At block 245, the user removes a device 238 from the first compartment 234 to operate the device 238 at a jobsite. At block 247, the user operates the locking mechanism of the security system 230 to unlock a second compartment 234. At block 249, the user removes another device 238 from the second compartment 234 to operate the device 238 at a jobsite. At block 251, the user returns the devices 238 to the first and second compartments 234 and operates the locking mechanism to lock the first and second compartments 234. As such, the second mode allows for multiple compartments 234 to be unlocked or locked simultaneously. A user can use the second mode to remove multiple devices 238 at one time. The locking mechanism can be operated either in the first mode or the second mode on a user interface that is electrically connected or wirelessly connected to the security system 230 so that the security system 230 is expandable.

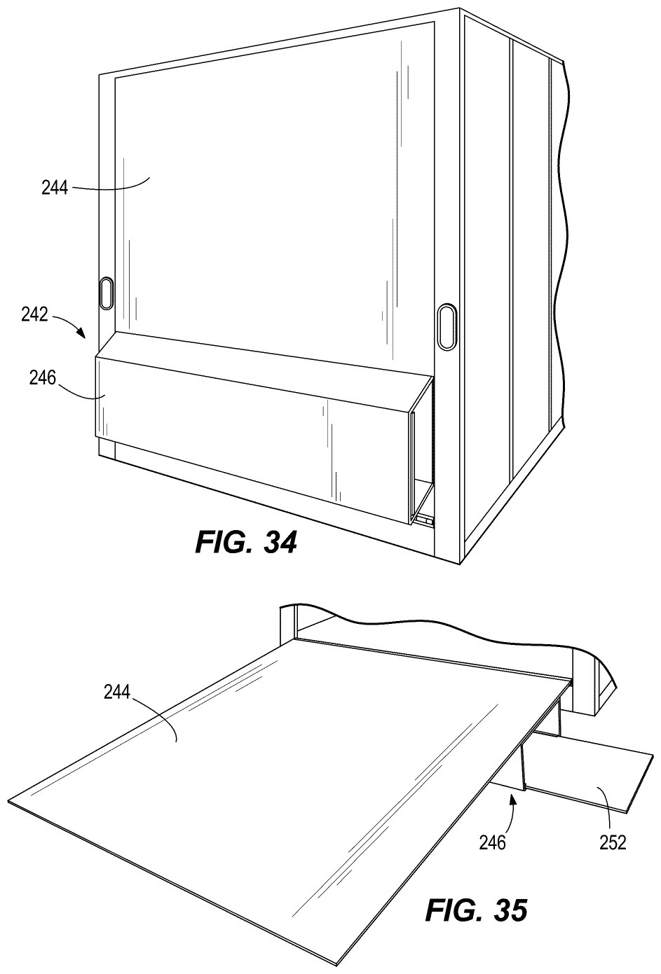

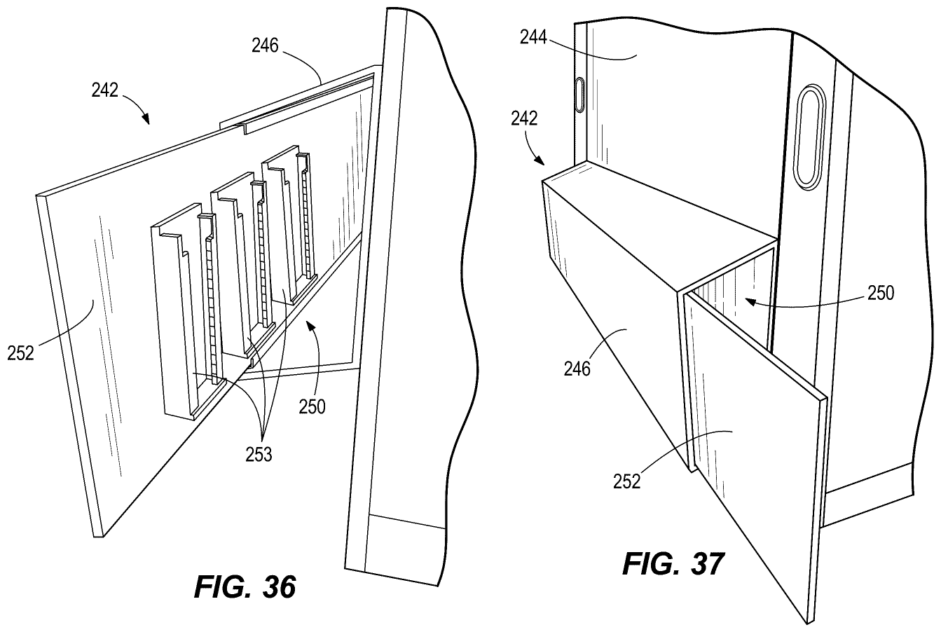

FIGS. 34-37 illustrates another embodiment of a charging station 242 configured to be securely coupled to an exterior of a wall 244 of an enclosed cargo trailer or a vehicle. The charging station 242 includes a housing 246 having a battery compartment 250 and a charging panel 252 stored in the battery compartment 250. The charging panel 252 is slidably mounted within the battery compartment 250. The charging station 242 further includes a plurality of battery chargers 253 (represented by a single battery charger 253 illustrated in FIG. 36). The plurality of battery chargers 253 are mounted onto the charging panel 252 and configured to charge a plurality of batteries (not shown). A user may slide the charging panel 252 out of the battery compartment 250 to provide access to the batteries. As such, spacing provided within the enclosed cargo trailer is not consumed by the charging station 242, resulting in a less disruptive adoption of special requirements needed for the charging station 242. The charging station 242 also provides security and ingress protection by enclosing the plurality of batteries within the housing 246 of the charging station 242.

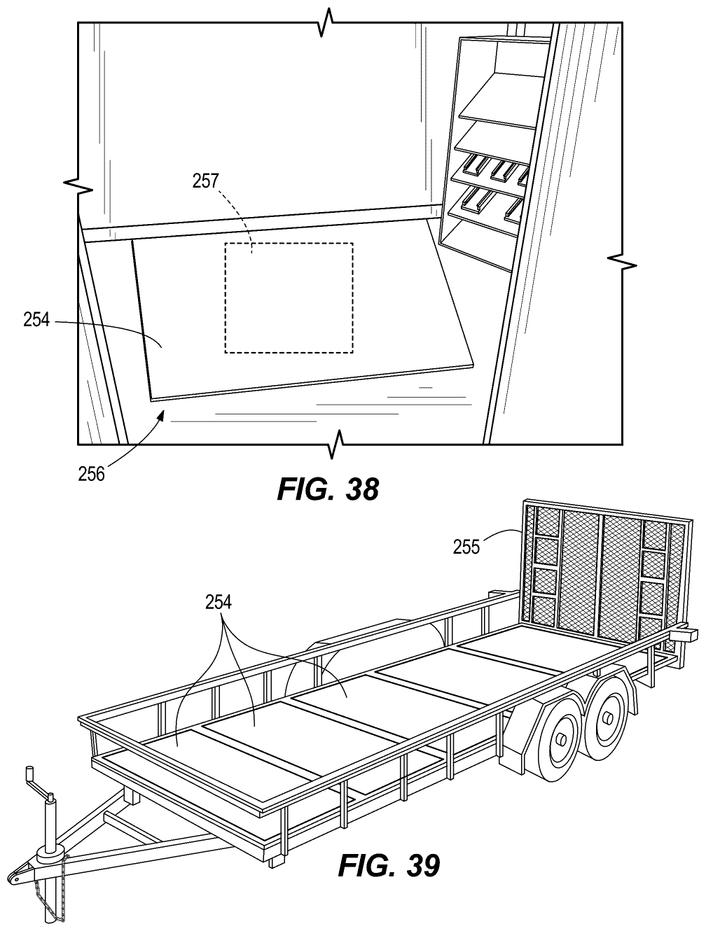

FIGS. 38 and 39 illustrate a battery pad 254 configured to serve as a false floor battery bank and not take up any floor space of a flatbed trailer 255 or an enclosed cargo trailer 256. The battery pad 254 further provides a power source for on-board charging during transportation. Specifically, the battery pad 254 is a low-profile, large core battery used to charge other batteries that are to be used in power tools (e.g., outdoor power tools). Since the battery pad 254 is sturdy enough, a user is capable of walking on the battery pad 254, as well as placing tool equipment 257 (e.g., outdoor power equipment) on top of the battery pad 254. The battery pad 254 has a thickness of about one cylindrical cell. In some embodiments, the battery pad 254 can be the same size as the floor provided within the trailers 256, 255. In other embodiments, the battery pad 254 can be a predetermined size that is smaller than the floor of the trailers 256, 255 to allow the battery pad 254 to be positioned anywhere within the trailers 256, 255. In addition, the battery pad 254 can be scalable, such that the battery pad 254 is expandable and retractable. The battery pad 254 is also modular to add more capacity to a trailer. The battery pad 254 further includes an interface that connects with various equipment (e.g., batteries, power tool, tool chest, tec.). The interface can be used to activate and deactivate a charging operation.

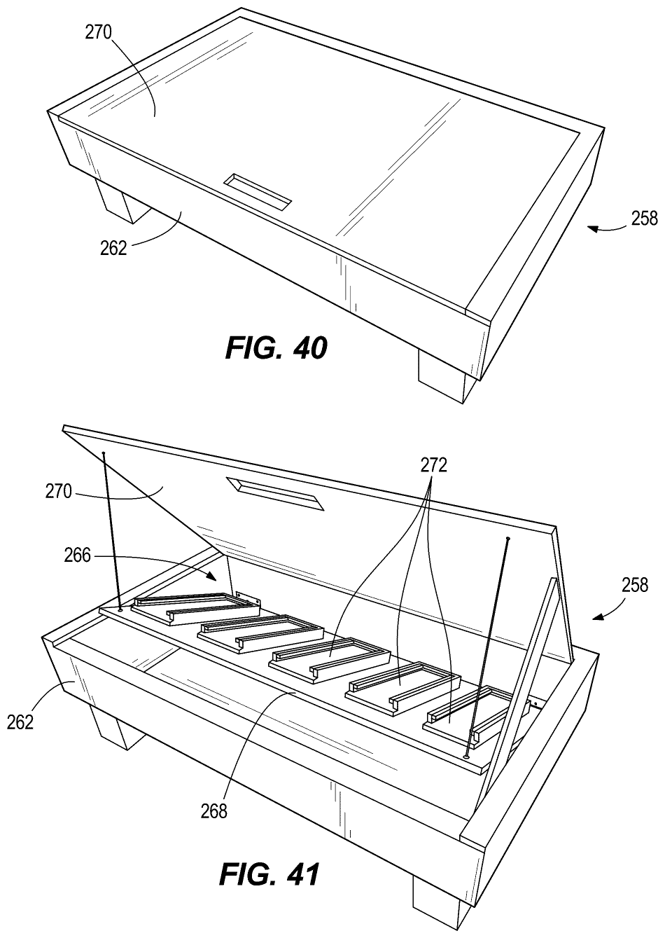

FIGS. 40 and 41 illustrate a floor hatch 258 providing a power source for on-board charging. The floor hatch 258 is configured to be assembled into a sub floor of a flatbed trailer to store and protect batteries or a charger mechanism. The floor hatch 258 includes a housing 262 having a storage compartment 266, a charging surface 268 pivotably coupled to the housing 262, and a lid 270 pivotably coupled to the housing 262 to allow access to the storage compartment 266. A plurality of battery chargers 272 is mounted on the charging surface 268 and configured to charge the batteries provided within the floor hatch 258. The storage compartment 266 can also be accessed from the back of the trailer when a gate of trailer is open. The housing 262 is formed to protect the storage compartment 266 from shade and has a venting system (not shown) that allows airflow throughout the floor hatch 258. In addition, the floor hatch 258 does not take up valuable space within the trailer while also protecting the storage compartment 266 from solar radiation. As such, the floor hatch 258 will be positioned under a floor of the flatbed trailer, thereby keeping the batteries and the charger mechanism out of sight. To protect the floor hatch 258 from elements that are placed under the flatbed trailer, a metal skid plate (not shown) can be attached to the housing 262. The metal skid plate can also serve as a heat sink.

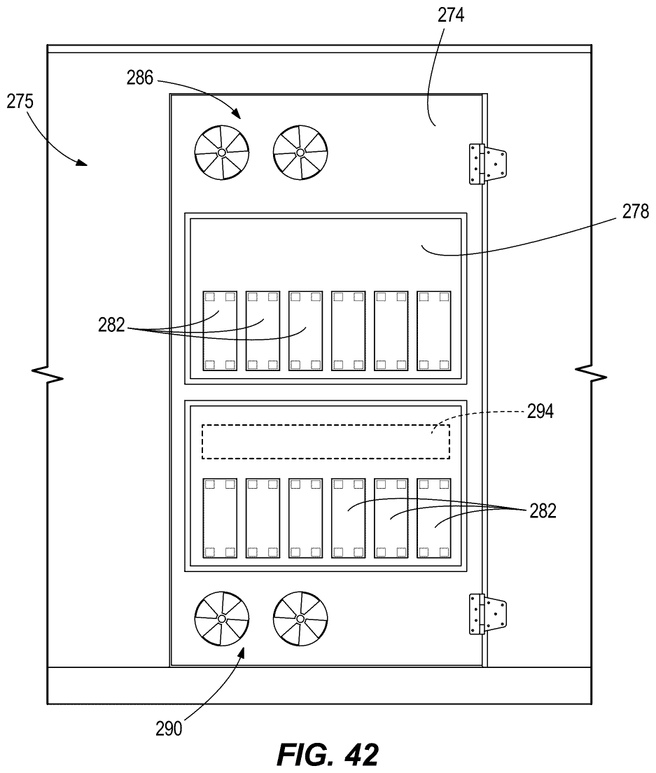

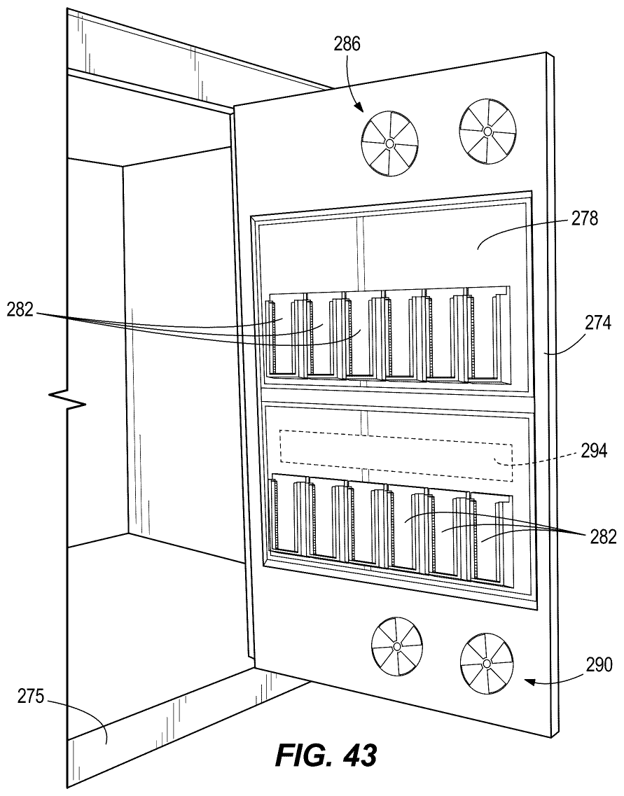

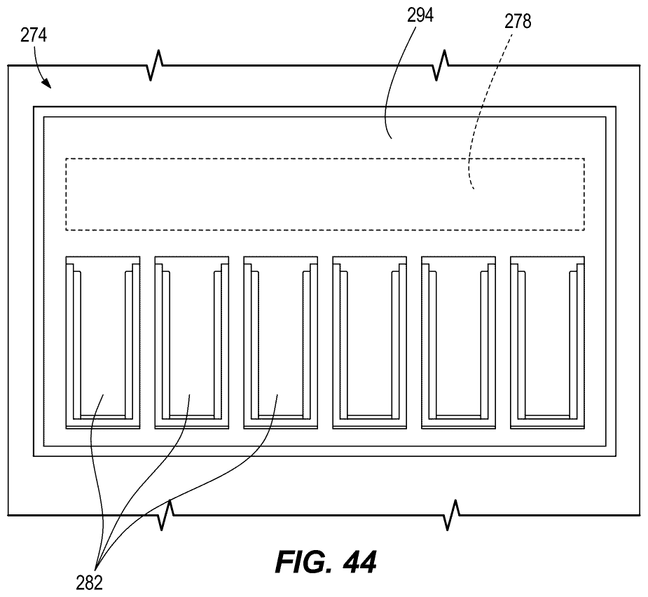

FIGS. 42-44 illustrate a battery charging door 274 configured to replace a door of an enclosed cargo trailer 275 to provide easy access to a charging station for batteries without entering the trailer 275. As such, the battery charging door 274 will provide more available space within the trailer 275. The battery charging door 274 can be easily installed on the trailer 275 to also reduce the environmental temperature within the trailer 275. During installation, an original door of the trailer 275 is removed from the hinges and then replaced by the battery charging door 274.

The battery charging door 274 includes a screen panel 278 and a plurality of battery chargers 282 that are mounted to the screen panel 278. The plurality of battery chargers 282 is configured to receive and charge batteries. The screen panel 278 allows airflow within the enclosed cargo trailer 275 so that the airflow constantly passes over the batteries. The battery charging door 274 further includes a first set of fans 286 positioned above the screen panel 278 and a second set of fans 290 positioned below the screen panel 278. The first and second sets of fans 286, 290 are used when the enclosed cargo trailer 275 needs forced convection. The first set of fans 286 blow air out of the trailer 275, while the second set of fans 290 blow air into the trailer 275. The battery charging door 274 further includes a display 294 configured to indicate a variety of information (e.g., the state of charge of the batteries, the temperature of the interior of the trailer, number of cycles, etc.)

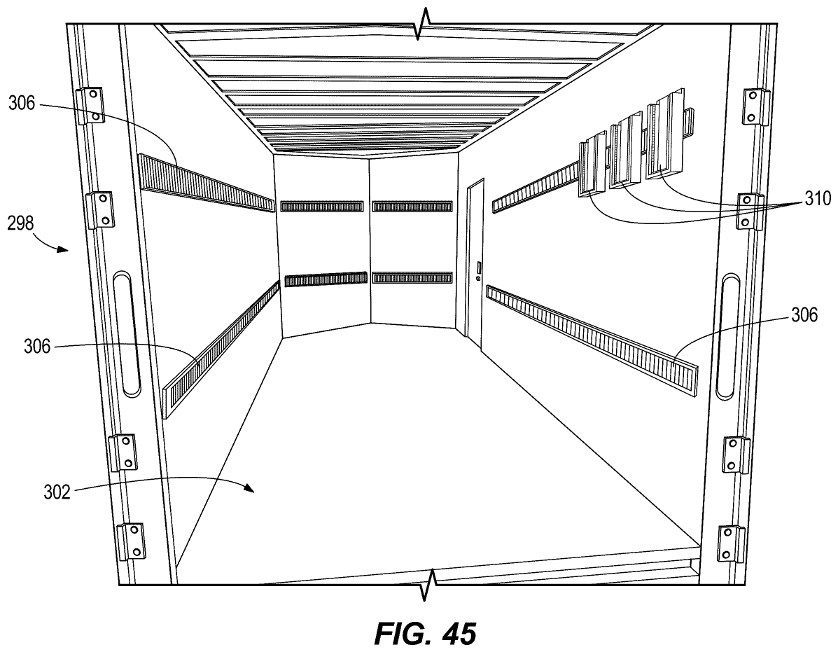

FIG. 45 illustrates an enclosed cargo trailer 298, in which an interior 302 of the trailer 298 is shown. The interior 302 of the trailer 298 includes an E-track 306 mounted on the walls of the trailer 298 and a plurality of battery chargers 310 configured to be mounted on the E-track 306 to flexibly arrange their space and position within the trailer 298. In some embodiments, the interior 302 of the trailer 298 includes a X-track for mounting and storage. The chargers 310 can also mount to the X-track. In other embodiments, an E-track or a X-track can be mounted for battery storage and not just for charging. The chargers 310 include a mounting mechanism positioned on the chargers 310, in which the mounting mechanism are compatible with the structure of the E-track 306. The E-track 306 is also integrated with a power distribution bus and includes a locking mechanism to ensure that the chargers 310 and the batteries are securely coupled to the E-track 306 to prevent theft.

Although the disclosure has been described in detail with reference to certain preferred embodiments, variations and modifications exist within the scope and spirit of one or more independent aspects of the disclosure as described.

What is claimed is:

1. A mobile charger for transporting and charging a plurality of batteries, the mobile charger comprising:
a base including a bottom portion and a top portion extending from the bottom portion;
a docking station slidably coupled to the top portion of the base such that the docking station is movable along the base; and
a plurality of charger interfaces coupled to the docking station, the plurality of charger interfaces configured to receive the plurality of batteries such that the plurality of batteries is charged by the base.

2. The mobile charger of claim 1, further comprising a handle coupled to the docking station, the handle configured to be grasped to move the docking station along the base.

3. The mobile charger of claim 2, wherein the handle is retractable within the docking station.

4. The mobile charger of claim 2, wherein the handle is a primary handle disposed on a top portion of the docking station, and wherein the mobile charger further comprises a pair of auxiliary handles disposed on opposite sides of the docking station.

5. The mobile charger of claim 1, wherein the docking station is removable from the base, and wherein the docking station can be stored in a modular storage unit configured to charge the plurality of batteries after the removal of the docking station from the base.

6. The mobile charger of claim 1, wherein the base stores electrical components used for charging the plurality of batteries.

7. The mobile charger of claim 1, wherein the base is configured to sequentially charge the plurality of batteries received by the plurality of charger interfaces.

8. The mobile charger of claim 1, wherein the base is configured to charge the plurality of batteries at a first charging rate that is faster than a second charging rate of a second mobile charger.

9. The mobile charger of claim 1, wherein the base is configured to charge the plurality of batteries at a standard charging rate.

10. The mobile charger of claim 1, further comprising a sensor system configured to sense a maximum power draw of a vehicle to maximize power drawn from the vehicle.

11. A mobile charger for transporting and charging a plurality of batteries, the mobile charger comprising:
a base including a bottom portion and a top portion having a pair of slots;
a docking station including a pair of railings received within the pair of slots of the top portion of the base to slidably couple the docking station to the base such that the docking station is movable along the base; and
a plurality of charger interfaces coupled to the docking station, the plurality of charger interfaces configured to receive the plurality of batteries such that the plurality of batteries is charged by the base.

12. The mobile charger of claim 11, further comprising a handle coupled to the docking station, the handle configured to be grasped to move the docking station along the base.

13. The mobile charger of claim 12, wherein the handle is retractable within the docking station.

14. The mobile charger of claim 12, wherein the handle is a primary handle disposed on a top portion of the docking station, and wherein the mobile charger further comprises a pair of auxiliary handles disposed on opposite sides of the docking station.

15. The mobile charger of claim 11, wherein the docking station is removable from the base, and wherein the docking station can be stored in a modular storage unit configured to charge the plurality of batteries after the removal of the docking station from the base.

16. The mobile charger of claim 11, wherein the base is configured to sequentially charge the plurality of batteries received by the plurality of charger interfaces.

17. A mobile charging system comprising:
a first mobile charger including a first base, a first docking station slidably coupled to the first base such that the first docking station is movable along the first base, and a first plurality of charger interfaces coupled to the first docking station, the first plurality of charger interfaces configured to receive a first plurality of batteries such that the first plurality of batteries is charged by the first base; and
a second mobile charger including a second base, a second docking station slidably coupled to the second base such that the second docking station is movable along the second base, and a second plurality of charger interfaces coupled to the second docking station, the second plurality of charger interfaces configured to receive a second plurality of batteries such that the second plurality of batteries is charged by the second base,
wherein the first mobile charger and the second mobile charger are coupled together.

18. The mobile charging system of claim 17, wherein the first mobile charger further includes a first handle and the second mobile charger further includes a second handle, and wherein the first and second handles are configured to be grasped to respectively move the first and second docking stations along the first and second bases.

19. The mobile charging system of claim 18, wherein the first and second handles are respectively retractable within the first and second docking stations.

20. The mobile charging system of claim 17, wherein the first mobile charger is configured to charge the first plurality of batteries at a first charging rate and the second mobile charger is configured to charge the second plurality of batteries at a second charging rate, and wherein the first charger rate is a faster rate than the second charging rate.
